(19) United States
(12) Patent Application Publication
(10) Pub. No.: US 2024/0356290 A1
(43) Pub. Date: Oct. 24, 2024

(54) SHIELDING CABLE CONNECTION STRUCTURE

(71) Applicant: Changchun Jetty Automotive Corporation, Changchun, Jilin (CN)

(72) Inventors: Chao WANG, Changchun, Jilin (CN); Chuan LIU, Changchun, Jilin (CN)

(73) Assignee: Changchun Jetty Automotive Technology Co., Ltd., Changchun, Jilin (CN)

(21) Appl. No.: 18/684,812

(22) PCT Filed: Aug. 19, 2022
(86) PCT No.: PCT/CN2022/113497

§ 371 Date: Feb. 19, 2024

(30) Foreign Application Priority Data
Aug. 21, 2021 (CN) 202110964139.8
Aug. 21, 2021 (CN) 202121972383.0

(51) Int. Cl. H01R 24/40; H01R 103/00

(52) U.S. Cl. CPC H01R 24/40; H01R 2103/00

(57) ABSTRACT

The present disclosure provides a shielding cable connection structure, including a connector and a shielding cable. The shielding cable includes a conductor core and a shielding layer, the connector is provided therein with a first inner cavity for accommodating the shielding cable, the connector includes a conductive layer, and the conductive layer is provided on an inner surface of the first inner cavity and is electrically connected to the shielding layer. By means of the present disclosure, the technical problem that electromagnetic interference is relatively serious at a connection position of the shielding cable is alleviated.

### RELATED APPLICATION

The present disclosure claims priority to Chinese Patent Application NO. 202110964139.8, filed on Aug. 21, 2021 and entitled “Shielding Cable Connection Structure”: and also claims priority to Chinese Utility Model Patent Application NO. 202121972383.0, filed on Aug. 21, 2021 and entitled “Shielding Cable Connection Structure”.

### TECHNICAL FIELD

The present disclosure relates to the technical field of electrical connection elements, and in particular to a shielding cable connection structure.

### BACKGROUND

High voltage cables and data communication cables are used for conducting current and signals. In order to reduce the impact of electromagnetic interference, high voltage cables and data communication cables are usually configured as shielding cables. At both ends of the cable, the shielding layer of the shielding cable is connected to the shielding device and is grounded.

The shielding cable usually includes a conductor core and a shielding layer provided sequentially from the inside to the outside. In order to facilitate connection to the mating cable or electrical equipment, the end of the cable is usually connected to the connector. The connector generally has no shielding device for shielding, resulting in a large electromagnetic interference at the location of the connector.

A metal cover is provided inside or outside the connector to play a shielding effect. However, the metal cover is difficult to process and has a high cost; it is also bothersome to assemble the metal cover with the connector, increasing the assembly labor-hours: and when the metal cover is within the connector, short circuit may easily occur between the metal cover and the conductor core, causing the shielding layer to be damaged or even the cable to be burned, resulting in a serious accident.

Therefore, the technical field of electrical connection elements is in an urgent need of a shielding cable connection structure that can alleviate the problem that electromagnetic interference is relatively serious at a connection position of the shielding cable.

### SUMMARY

The present disclosure aims to provide a shielding cable connection structure to alleviate the technical problem of relatively serious electromagnetic interference at a connection position of the shielding cable.

The above purpose of the present disclosure can be achieved by adopting the following technical solution:
the present disclosure provides a shielding cable connection structure including a connector and a shielding cable, and the shielding cable includes a conductor core and a shielding layer, the connector is provided therein with a first inner cavity for accommodating the shielding cable, the connector includes a conductive layer, and the conductive layer is provided on an inner surface of the first inner cavity and is electrically connected to the shielding layer.

The present disclosure has the following characteristics and advantages:
1. In the shielding cable connection structure, the connector encloses an end portion of the cable and a terminal of the cable, and the conductive layer is electrically connected to the shielding layer of the cable, and the conductive layer and the shielding layer of the cable enclose the conductor core of the cable, to safely shield the cable and the terminal connected to the end of the cable, thereby reducing the impact of electromagnetic interference. The shielding cable connection structure eliminates the metal cover, is easily to assemble, saves processing time and reduces the cost of the shielding cable connection structure.
2. In the shielding cable connection structure, a shielding device is provided, so as to make the conductive layer of the connector to be connected with the shielding layer of the shielding cable more stably and obtain better shielding effect.
3. In the shielding cable connection structure, a conductive elastic sheet is provided, so as to apply pressure to the shielding layer or the shielding device to obtain better conductive effect, and to facilitate easy plug-in connection of the cable with the conductive layer to save assembly time and improve production efficiency.
4. In the shielding cable connection structure, the impedance at the connection position and the transfer impedance range of the conductive layer itself are set, so that the material selection of the conductive layer and the design of the connection position can be more standardized.
5. In the shielding cable connection structure, the conductive layer, the shielding device, the conductive elastic sheet, the insulating housing and the insulating protective layer can be made of a variety of materials, thereby increasing the selection range for designers, and adding many corresponding material selection design schemes for different use environments.

### BRIEF DESCRIPTION OF THE DRAWINGS

The following drawings are intended only to schematically illustrate and explain the present disclosure and do not limit the scope of the present disclosure. In the drawings,

FIGS. 1 to 10 are structural schematic diagrams of the shielding cable connection structure according to the present disclosure:

FIGS. 11 to 12 are structural schematic diagrams of the conductive elastic sheet in the shielding cable connection structure according to the present disclosure.

### DESCRIPTION OF EMBODIMENTS

For a clearer understanding of the technical features, objects and effects of the present disclosure, specific embodiments of the present disclosure will now be described with reference to the accompanying drawings. In description of the present disclosure, “a plurality of” means two or more, unless otherwise indicated.

### First Solution

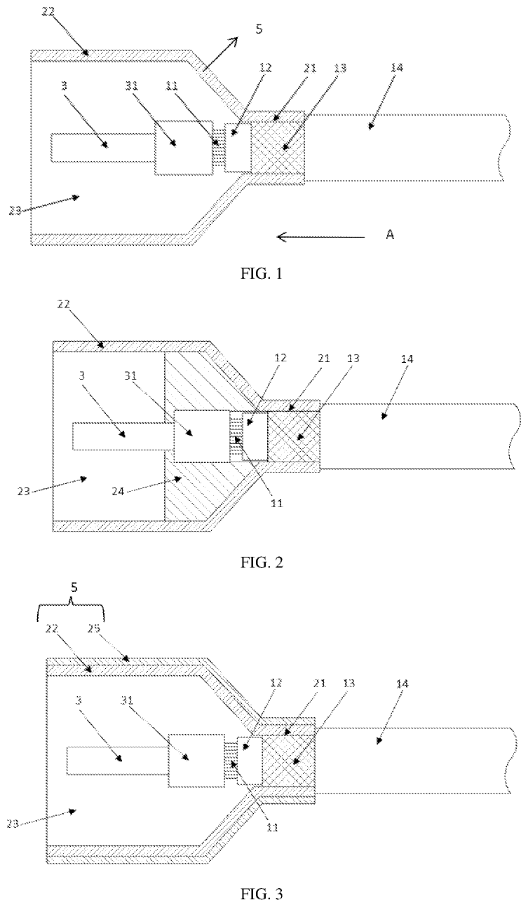

The present disclosure provides a shielding cable connection structure, as shown in FIGS. 1 to 3, the shielding cable connection structure includes a connector 5 and a shielding cable. The shielding cable includes a conductor core 11 and a shielding layer 13, the connector 5 is provided therein with a first inner cavity 21 for accommodating the shielding cable, and the connector 5 includes a conductive layer 22, and the conductive layer 22 is provided on an inner surface of the first inner cavity 21 and is electrically connected to the shielding layer 13.

Due to the transmission of high current, high voltage cables generate a large electromagnetic field is generated when the current passes through them. In order to prevent the electromagnetic field generated by the high current from causing electromagnetic interference to electrical appliances in the surrounding environment and thus affecting the normal operation of other electric apparatuses, it is therefore desirable to electromagnetically shield the electromagnetic field generated by the high current. The data communication cable, by contrast, transmits an electromagnetic signal inside. The electromagnetic signal may be interfered by the external electromagnetic field, resulting in the distortion of the electromagnetic signal, thus the signal cannot be effectively transmitted. Therefore, electromagnetic shielding is needed to shield the interference of the external electromagnetic field.

The electromagnetic shielding refers to that mainly a shield body is used to prevent the influence of high-frequency electromagnetic field, so as to effectively control the radiation transmission of electromagnetic waves from a certain area to another area. The basic principle is that, the shield body is made of conductor material with a low resistance, the electromagnetic wave is reflected on the surface of the shield body, absorbed inside the shield body and lost in the transmission process to produce shielding effect.

In some embodiments, as shown in FIG. 1, the whole connector 5 itself is composed of the conductive layer 22, which has a simple structure and can achieve a better shielding effect.

In this embodiment, in the shielding cable connection structure, the connector 5 encloses an end portion of the cable and a terminal 3 of the cable, and the conductive layer 22 is electrically connected to the shielding layer 13 of the shielding cable, and the conductive layer 22 and the shielding layer 13 of the shielding cable enclose the conductor core 11 of the cable, to safely shield the conductor core 11 and the terminal 3 connected to the end of the conductor core 11, thereby reducing the impact of electromagnetic interference. The shielding cable connection structure eliminates the metal cover, is easily to assemble, saves processing time and reduces the cost of the shielding cable connection structure.

In an embodiment, the conductive layer 22 wraps at least part of the periphery of the shielding layer 13, and the conductive layer 22 is in contact with the shielding layer 13 in a surrounding manner at 360° and is electrically connected to the shielding layer 13, to form an electromagnetic shielding structure that encloses the internal conductor core 11 and the terminal 3, thereby optimizing the electromagnetic shielding effect. If there are various gaps in the electromagnetic shielding structure, the integrity of the electromagnetic shielding may be affected to different degrees, and the electromagnetic waves may radiate out of or into the electromagnetic shielding structure through the gaps, thereby resulting in electromagnetic interference. In the prior art, the shielding layer formed by a woven net is usually broken up, and then a strand of wire is formed and welded with the metal shielding shell, so that the electromagnetic interference radiates out of or into the gap of the broken shielding layer, affecting the transmission of signals. In addition, if the conductive layer 22 is connected to the shielding layer 13 at a single point, high current may flow through the connection position, resulting in the generation of a magnetic field. Then this generated magnetic field may be coupled with the magnetic field generated by the conductor core 11, which causes great radiation at the entire cable connection, seriously affecting the working state of other electrical appliances. In this embodiment, the conductive layer 22 wraps at least part of the periphery of the shielding layer 13 to form a closed electromagnetic shielding structure, so as to effectively control the radiation of electromagnetic waves and achieve good shielding effect.

In an embodiment, a terminal 3 and an insulating housing 24 are also included, and the terminal 3 includes a connection end 31, and the connection end 31 is electrically connected to the conductor core 11; the insulating housing 24 is provided with a second inner cavity 23 for accommodating the terminal 3, and the conductive layer 22 wraps at least part of the periphery of the insulating housing 24.

For the shielding cable connection structure in this embodiment, in general, the termination of the cable needs to be mutually plugged into an electrical device or other connectors to form an electrical circuit, and the terminal 3 is installed in the second inner cavity 23 of the insulating housing 24, an mating terminal of the electrical device or other connectors may be electrically connected to the terminal 3, and in addition, the connector 5 is capable of being plugged with the electrical device or other connectors. The insulating housing 24 is provided inside the conductive layer 22 in order to isolate the conductive layer 22 and the terminal 3 to avoid short circuit due to contact between the conductive layer 22 and the terminal 3. The shielding cable connection structure can ensure the safe shielding effect of the connection position between the terminal 3 and the mating terminal, greatly reducing the impact of electromagnetic interference. As shown in FIG. 1, the direction A in which the cable is penetrated may be a direction in which the first inner cavity 21 points to the second inner cavity 23.

The connector 5 is cylindrical in shape as a whole. In an embodiment, the connector 5 includes an insulating protective layer 25. As shown in FIG. 3, the insulating protective layer 25 is provided on at least part of the periphery of the conductive layer 22. The conductive layer 22 has a shielding function. The outer side of the conductive layer 22 is protected by the insulating protective layer 25 to avoid conducting electricity with the surrounding and ensure the shielding effect.

In an embodiment, as shown in FIG. 1, the shielding cable further includes an inner insulating layer 12 within which the conductor core 11 is provided, and the shielding layer 13 wraps at least part of the periphery of the inner insulating layer 12. The function of the inner insulating layer 12 is to insulate the conductor core 11 and the shielding cable to avoid short circuit due to contact between the conductor core 11 and the shielding cable.

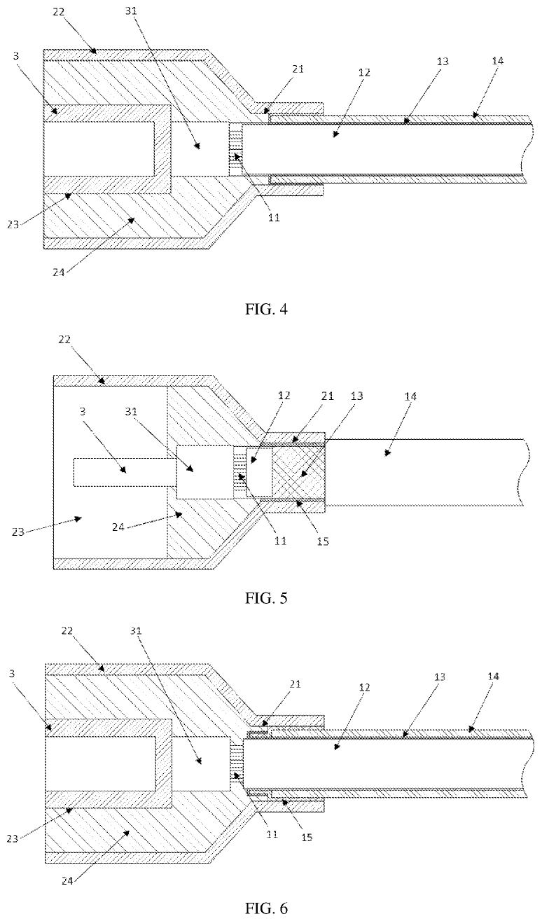

In an embodiment, the shielding cable further includes an outer insulating layer 14, and as shown in FIG. 4, the shielding layer 13 is provided within the outer insulating layer 14, and the end of the shielding layer 13 that is located in the first inner cavity 21 is folded over outwards to wrap at least part of the periphery of the outer insulating layer 14. The shielding layer 13 may be a shielding net, or a conductive foil wrapping the inner insulating layer 12. When the shielding layer 13 is cut or stripped, free metal wire will appear, and when the metal wire is to be contact with the conductor core 11, a short circuit or shielding failure will occur. Therefore, in the processing of the general shielding cable connection structure, the shielding layer 13 is folded over outwards to wrap at least part of the periphery of the outer insulating layer 14, and then is electrically connected with the conductive layer 22 to avoid the contact between the shielding layer 13 and the conductor core 11.

In an embodiment, the shielding cable further includes a shielding device 15 which is provided on at least part of the periphery of the shielding layer 13, and the shielding layer 13 is electrically connected to the conductive layer 22 through the shielding device 15. The shielding layer 13 may be a shielding net, or a conductive wrapping the inner insulating layer 12. The shielding layer 13 is a soft structure, while the conductive layer 22 is generally a hard structure. When the shielding layer 13 is in contact with the conductive layer 22, due to the deformation of the shielding layer 13, the conductive layer 22 may be disconnected from the shielding layer 13 transitorily, thus, the impedance at contact position changes, resulting in unstable shielding effect of the shielding cable connection structure, thereby affecting the signal transmission. Therefore, it is necessary to use a shielding device 15 to be stably connected with a shielding net, and the shielding device 15 is generally a hard structure to be well electrically connected to the conductive layer 22, so as to achieve a stable shielding effect.

Further, the shielding device 15 is connected to the shielding layer 13 by means of crimping or welding or bonding. In this embodiment, the shielding device 15 is a metal ring, and as shown in FIG. 5, the shielding device 15 is sleeved over the shielding layer 13 and connected to it by crimping or welding or bonding.

The crimping refers to that crimping pincers or crimping equipment may be used to exert a certain acting force on the shielding device 15 so that the shielding device 15 deforms inwards, and compresses the shielding layer 13, such that the shielding net 13 and the shielding device 15 are relatively fixed and form a large contact area to ensure good electrical connection.

The welding method, which includes laser welding, ultrasonic welding, resistance welding, pressure diffusion welding or brazing, is to use concentrated heat or pressure to make the shielding net 13 and the shielding device 15 be fusion connected at the contact position. The welding method can realize stable connection, and can also realize connection of dissimilar materials, and can achieve better conductive effect due to the fusion at the contact position.

The bonding refers to that, a conductive adhesive is used to bond the shielding net 13 with the shielding device 15, which does not require the use of equipment, and does not heat or deform the shielding net 13 and the shielding device 15. Through the conductive adhesive, the shielding net 13 and shielding device 15 are fully electrically connected, which achieves a good conductive effect but a low connection strength, and thus is suitable for the use environment which does not require high connection strength and in which the shielding net 13 and the shielding device 15 have low melting point or low strength.

Further, as shown in FIG. 6, the shielding device 15 includes a first collar and a second collar that are distributed longitudinally. An inner diameter of the first collar is less than an inner diameter of the second collar. The shielding layer 13 is folded over outwards to wrap at least part of the periphery of the first collar, and the shielding layer 13 is fixedly connected to the first collar, and the second collar is electrically connected to the conductive layer 22. As mentioned above, during the processing of the general shielding cable connection structure, the shielding layer 13 is folded over outwards to wrap at least part of the periphery of the outer insulating layer 14, and then electrically connected to the conductive layer 22 to avoid contact between the shielding layer 13 and the conductor core 11. In this embodiment, in a form of a stepped collar, the shielding layer 13 is folded outwards to wrap at least part of the periphery of the first collar, so as to be able to avoid contact between the shielding layer 13 and the conductor core 11, and a good electrical connection is formed between the second collar and the conductive layer 22, thus achieving a stable shielding effect.

The second collar is connected with the first collar in sequence in the cable penetration direction A, the second collar sleeves at least part of the periphery of the outer insulating layer 14, and the outer wall of the second collar is in contact fit with the inner wall of the conductive layer 22.

The shielding layer 13 and the first collar may be fixedly connected by crimping or welding or bonding, as described above.

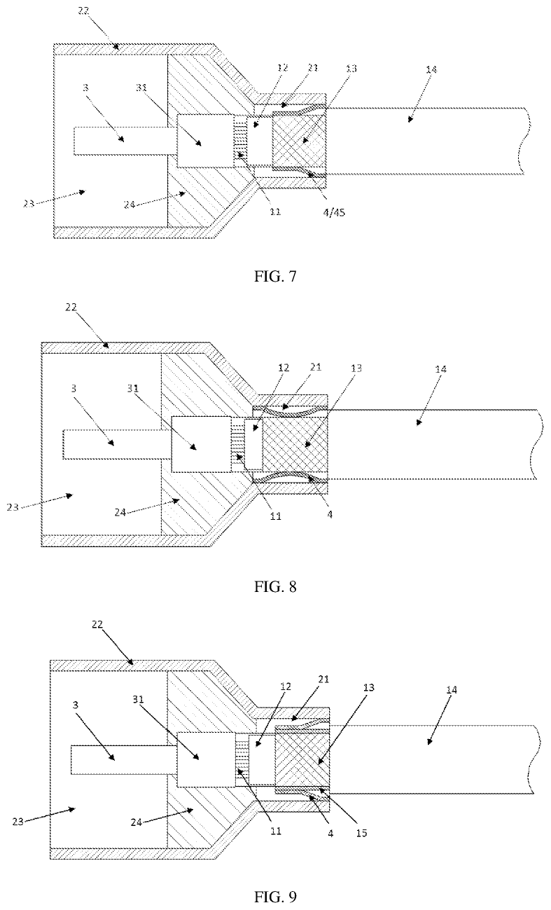

In an embodiment, a conductive elastic sheet 4 provided on the inner surface of the first inner cavity 21 is further included. As shown in FIGS. 7 and 8, the conductive elastic sheet 4 is in contact connection to the shielding layer 13 and exerts pressure on the shielding layer 13. The conductive layer 22 is electrically connected with the shielding layer 13 through the conductive elastic sheet 4. At least part of the conductive elastic sheet 4 is elastic, and the at least part has a tendency to shrink inwards to compress the shielded cable. In this way, the stability of the electrical connection between the conductive layer 22 and the shielding layer 13 is ensured on one hand, and on the other hand, the shielding cable is capable of being in contact connection with the conductive elastic sheet 4 when it is penetrated into the first inner cavity 21 in the cable penetration direction A, thereby facilitating to assemble the shielding cable with the connector 5, and saving assembly and processing time.

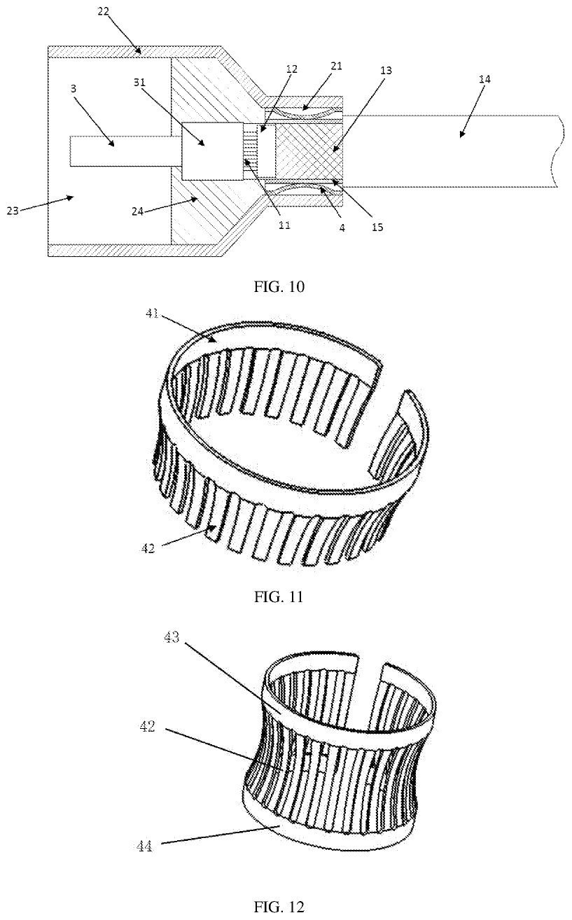

In an embodiment, a conductive elastic sheet 4 provided on the inner surface of the first inner cavity 21 is further included. As shown in FIGS. 9 and 10, the conductive elastic sheet 4 is in contact connection to the shielding device 15 of the shielding cable and exerts pressure on the shielding device 15. The conductive layer 22 is electrically connected with the shielding device 15 through the conductive elastic sheet 4. At least part of the conductive elastic sheet 4 is elastic, and the at least part has a tendency to shrink inwards to compress the shielded device 15. In this way, the stability of the electrical connection between the conductive layer 22 and the shielding device 15 is ensured on one hand, and on the other hand, the shielding cable is capable of being in contact connection with the conductive elastic sheet 4 when it is penetrated into the first inner cavity 21 in the cable penetration direction A, thereby facilitating to assemble the shielding cable with the connector 5, and saving assembly and processing time.

Further, the pressure exerted by the conductive elastic sheet 4 is in a range of 0.3 N to 95 N. Exemplarily, the pressure exerted by the conductive elastic sheet 4 is in a range of 0.5 N to 50 N.

In order to verify the effect of the pressure exerted by the conductive elastic sheet 4 on the shield layer 13 on the contact resistance between the conductive elastic sheet 4 and the shielding layer 13, the inventor carries out a targeted test, taking the pressure exerted by the conductive elastic sheet 4 on the shielding layer 13 as an example, the inventor uses the conductive elastic sheet 4 and the shielding layer 13 of the same shape and the same size, and designs different pressures between the conductive elastic sheet 4 and the shielding layer 13 to observe the contact resistance between the conductive elastic sheet 4 and the shielding layer 13.

TABLE 1
Influence of different pressures between the conductive elastic
sheet and the shielding layer on the contact resistance
Pressure exerted by the conductive elastic sheet 4 on the shielding layer (N)

| | | | | | | | | | | | | | | | | | |
|---|---|---|---|---|---|---|---|---|---|---|---|---|---|---|---|---|---|
| 0.1 | 0.2 | 0.3 | 0.5 | 1 | 5 | 10 | 20 | 30 | 40 | 50 | 60 | 70 | 80 | 90 | 95 | 100 | 105 |

Contact resistance (μΩ)

| | | | | | | | | | | | | | | | | | |
|---|---|---|---|---|---|---|---|---|---|---|---|---|---|---|---|---|---|
| 63 | 56 | 49 | 42 | 40 | 38 | 35 | 33 | 30 | 26 | 22 | 18 | 14 | 12 | 11 | 10 | 10 | 9 |

The contact resistance is detected by using a micro resistance measurement instrument, which measures the resistance at the contact position between the conductive elastic sheet 4 and the shielding layer, and reads the numerical value on the micro resistance measurement instrument, and in this embodiment, the contact resistance less than 50 μΩ is ideal.

As can be seen from Table 1, when the pressure between the conductive elastic sheet 4 and the shielding layer 13 is less than 0.3 N, the contact resistance therebetween is higher than the ideal value because the binding force is too small, which does not meet the requirement. When the pressure between the conductive elastic sheet 4 and the shielding layer 13 is greater than 95 N, the contact resistance is not significantly reduced, but the material selection and processing are more difficult, and excessive pressure may cause damage to the shielding layer 13. Therefore, the inventor sets the pressure exerted by the conductive elastic sheet 4 to be 0.3 N to 95 N.

In addition, the inventor finds that when the pressure between the conductive elastic sheet 4 and the shielding layer 13 is greater than 0.5 N, the contact resistance value between the conductive elastic sheet 4 and the shielding layer 13 is relatively good and is decreased very fast, and when the pressure between the conductive elastic sheet 4 and the shielding layer 13 is less than 50 N, the conductive elastic sheet is convenient to manufacture, install and use, and also has low cost. Therefore, the inventor exemplarily sets the pressure exerted by the conductive elastic sheet 4 to be 0.5 N to 50 N.

In order to verify the effect of the pressure exerted by the conductive elastic sheet 4 on the shield device 15 on the contact resistance between the conductive elastic sheet 4 and the shielding device 15, the inventor carries out a targeted test, taking the pressure exerted by the conductive elastic sheet 4 on the shielding device 15 as an example, the inventor uses the conductive elastic sheet 4 and the shielding device 15 of the same shape and the same size, and designs the different pressures between the conductive elastic sheet 4 and the shielding device 15 to observe the contact resistance between the conductive elastic sheet 4 and the shielding device 15.

TABLE 2
Influence of different pressures between the conductive elastic
sheet and the shielding device on the contact resistance
Pressure exerted by the conductive elastic sheet 4 on the shielding device 15 (N)

| | | | | | | | | | | | | | | | | | |
|---|---|---|---|---|---|---|---|---|---|---|---|---|---|---|---|---|---|
| 0.1 | 0.2 | 0.3 | 0.5 | 1 | 5 | 10 | 20 | 30 | 40 | 50 | 60 | 70 | 80 | 90 | 95 | 100 | 105 |

Contact resistance (μΩ)

| | | | | | | | | | | | | | | | | | |
|---|---|---|---|---|---|---|---|---|---|---|---|---|---|---|---|---|---|
| 64 | 55 | 49 | 43 | 40 | 37 | 35 | 32 | 30 | 25 | 22 | 17 | 14 | 12 | 11 | 11 | 10 | 10 |

The contact resistance is detected by using a micro resistance measurement instrument, which measures the resistance at the contact position between the conductive elastic sheet 4 and the shielding device 15, and reads the numerical value on the micro resistance measurement instrument, and in this embodiment, the contact resistance less than 50 μΩ is ideal.

As can be seen from Table 2, when the pressure between the conductive elastic sheet 4 and the shielding device 15 is less than 0.3 N, the contact resistance therebetween is higher than the ideal value because the binding force is too small, which does not meet the requirement. When the pressure between the conductive elastic sheet 4 and the shielding device 15 is greater than 95 N, the contact resistance is not significantly reduced, but the material selection and processing are more difficult, and excessive pressure may cause damage to the shielding device 15. Therefore, the inventor sets the pressure exerted by the conductive elastic sheet 4 to be 0.3 N to 95 N.

In addition, the inventor finds that when the pressure between the conductive elastic sheet 4 and the shielding device 15 is greater than 0.5 N, the contact resistance value between the conductive elastic sheet 4 and the shielding device 15 is relatively good and is decreased very fast, and when the pressure between the conductive elastic sheet 4 and the shielding device 15 is less than 50 N, the conductive elastic sheet is convenient to manufacture, install and use, and also has low cost. Therefore, the inventor exemplarily sets the pressure exerted by the conductive elastic sheet 4 to be 0.5 N to 50 N.

In an embodiment, as shown in FIG. 7, one end of the conductive elastic sheet 4 is fixed on the inner surface of the first inner cavity 21, and the other end of the conductive elastic sheet has a minimum inner diameter in a free state less than or equal to an outer diameter of the shielding layer 13. In this way, the conductive layer 22 and the shielding layer 13 are electrically connected through the conductive elastic sheet 4.

In an embodiment, as shown in FIG. 9, one end of the conductive elastic sheet 4 is fixed on the inner surface of the first inner cavity 21, and the other end of the conductive elastic sheet has a minimum inner diameter in a free state less than or equal to an outer diameter of the shielding device 15. The conductive layer 22 and the shielding device 15 are electrically connected through the conductive elastic sheet 4.

At least part of the conductive elastic sheet 4 is elastic. One end of the conductive elastic sheet 4 that is crimped to the shielding layer 13 has a minimum inner diameter in a free state less than or equal to the outer diameter of the shielding layer 13 or the shielding device 15, such that when the conductive elastic sheet 4 is in contact connection with the shielding layer 13 or the shielding device 15, the conductive elastic sheet 4 exerts pressure inwards on the shielding layer 13 or the shielding device 15.

The inner diameter of the conductive elastic sheet 4 is gradually reduced in the cable penetration direction. One end of the conductive elastic sheet 4 that has a smaller inner diameter is crimped to the shielding layer 13 or the shielding device 15, and the other end of the conductive elastic sheet 4 that has a greater inner diameter is fixed on the inner surface of the first inner cavity 21, to facilitate the cable to enter the first inner cavity 21 in the cable penetration direction.

As shown in FIGS. 7 and 9, the conductive elastic sheet 4 includes a shrinking portion of which an inner diameter is gradually reduced in the cable penetration direction. Two ends of the shrinking portion 45 are respectively provided with a first cylindrical portion that is in contact connection to the shielding layer 13 or the shielding device 15 and a second cylindrical portion that is fixed on the inner surface of the first inner cavity 21, and the inner diameter of the first cylindrical portion is less than the inner diameter of the second cylindrical portion.

In an embodiment, as shown in FIG. 8, both ends of the conductive elastic sheet 4 are fixed on the inner surface of the first inner cavity, and a middle portion of the conductive elastic sheet 4 has a minimum inner diameter in a free state which is less than or equal to an outer diameter of the shielding layer 13.

In an embodiment, as shown in FIG. 10, both ends of the conductive elastic sheet 4 are fixed on the inner surface of the first inner cavity, and a middle portion of the conductive elastic sheet 4 has a minimum inner diameter in a free state which is less than or equal to an outer diameter of the shielding device 15.

As shown in FIGS. 8 and 10, both ends of the conductive elastic sheet 4 are fixed on the inner surface of the first inner cavity 21, and the middle portion of the conductive elastic sheet 4 shrinks inwards to be in contact connection to the shielding layer 13 or the shielding device 15.

At least part of the conductive elastic sheet 4 is elastic. The middle portion of the conductive elastic sheet 4 has a minimum inner diameter in a free state which is less than or equal to an outer diameter of the shielding layer 13 or the shielding device 15, such that the middle portion of the conductive elastic sheet 4 exerts pressure inwards on the shielding layer 13 or the shielding device 15.

In an embodiment, the conductive elastic sheet 4 includes a base strip 41 and a plurality of elastic sheets 42. As shown in FIGS. 7, 9 and 11, the base strip 41 is fixed on the inner surface of the first inner cavity 21, the plurality of elastic sheets 42 are fixed on the base strip 41, and the other end of the conductive elastic sheet 4 is a free end and is in contact connection to the shielding layer 13 or the shielding device 15. The elastic sheets 42 are elastic. One end of the conductive elastic sheet 4 that is in contact connection to the shielding layer 13 or the shielding device 15 has a minimum inner diameter in a free state which is less than or equal to the outer diameter of the shielding layer 13 or the shielding device 15, such that when the conductive elastic sheet 4 is crimped to the shielding layer 13, the conductive elastic sheet 4 exerts pressure inwards on the shielding layer 13 or the shielding device 15.

In an embodiment, the number of the base strip 41 is two, both base strips 41 are fixed on the inner surface of the first inner cavity, and both ends of each of the plurality of elastic sheets 42 are fixed on the two base strips 41 respectively. The base strip 41 includes a first base strip 43 and a second base strip 44. As shown in FIGS. 8, 10 and 12, both the first base strip 43 and the second base strip 44 are fixed on the inner surface of the first inner cavity 21. One end of the elastic sheet 42 is fixed on the first base strip 43 and the other end of the elastic sheet 42 is fixed on the second base strip 44, and the middle portion of the elastic sheet 42 shrinks inwards to be in contact connection to the shielding layer 13 or the shielding device 15.

In an embodiment, as shown in FIG. 7, the base strip 41 is connected to the inner surface of the first inner cavity 21 by welding, bonding, integrated injection molding, embedding or clamping. As shown in FIG. 8, the first base strip 43 is connected to the inner surface of the first inner cavity 21 by welding, bonding, integrated injection molding, embedding or clamping, and the second base strip 44 is connected to the inner surface of the first inner cavity 21 by welding, bonding, integrated injection molding, embedding or clamping.

The welding, which includes laser welding, ultrasonic welding, resistance welding, pressure diffusion welding or brazing, is to use concentrated heat or pressure to make the base strip 41 and the inner surface of the first inner cavity 21 be fusion connected at the contact position. The welding method can realize stable connection, and can also realize connection of dissimilar materials, and can achieve better conductive effect due to the fusion at the contact position.

The bonding refers to that, a conductive adhesive is used to bond the base strip 41 and the inner surface of the first inner cavity 21, which does not require the use of equipment, and does not heat or deform the base strip 41 and the inner surface of the first inner cavity 21. Through the conductive adhesive, the base strip 41 and the inner surface of the first inner cavity 21 are fully electrically connected, which achieves a good conductive effect but a low connection strength, and thus is suitable for the use environment which does not require high connection strength and in which the base strip 41 and the inner surface of the first inner cavity 21 have low melting point or low strength.

The integrated injection molding refers to that, the conductive elastic sheet 4 is placed into an injection mold, and when the connector is processed, it is directly and integrally injected onto the inner surface of the first inner cavity 21, such processing is simple and fast, and there is no other assembly process, thereby saving the assembly time.

The embedding refers to that, a groove is provided on the inner surface of the first inner cavity 21, then the first base strip 43 and/or the second base strip 44 of the conductive elastic sheet 4 are embedded into the groove so that the conductive elastic sheet 4 is fixed on the inner surface of the first inner cavity 21.

The clamping refers to that, a clamping claw or a clamping slot is provided on the inner surface of the first inner cavity 21, and the corresponding clamping slot or clamping claw is provided on the base strip 41, and then the clamping claw and the clamping slot are assembly connected so that the conductive elastic sheet 4 is fixed on the inner surface of the first inner cavity 21.

In an embodiment, an impedance between the conductive layer 22 and the shielding layer 13 is less than 80 mΩ. The impedance between the conductive layer 22 and the shielding layer 13 should be as less as possible, so that the current generated by the shielding layer 13 may flow back without hinder to the energy source or the grounding position. If the impedance between the conductive layer 22 and the shielding layer 13 is large, high current will be generated between the conductive layer 22 and the shielding layer 13, resulting in a large radiation generated at the cable connection.

In order to verify the influence of impedance value between the conductive layer 22 and the shielding layer 13 on the shielding effect of the shielding cable connection structure, the inventor uses the connector 5, the cable and the terminal 3 of the same specification, selects different impedances between the conductive layer 22 and the shielding layer 13 to make a series of samples of the shielding cable connection structure, to respectively test the shielding effect of the shielding cable connection structure, and the experimental results are shown in Table 3 below. In this embodiment, the shielding performance value of the shielding cable connection structure greater than 40 dB is the ideal value. The test method of the shielding performance value is to use a test instrument to output a signal value (this value is the test value 2) to the shielding cable, and to provide a detection device outside the shielding cable, and the detection device detects a signal value (this value is the test value 1). Shielding performance value is equal to the test value 2 minus the test value 1.

TABLE 3
Influence of impedance between the conductive layer 22 and the
shielding layer 13 on the shielding performance

| | Impedance between the conductive layer 22 and the shielding layer 13 (mΩ) | | | | | | | | | | |
|---|---|---|---|---|---|---|---|---|---|---|---|
| Measurement parameter | 5 | 10 | 20 | 30 | 40 | 50 | 60 | 70 | 80 | 90 | 100 |
| Shielding performance | 75 | 73 | 70 | 66 | 63 | 57 | 54 | 47 | 41 | 33 | 29 |
| value (dB) | | | | | | | | | | | |

As can be seen from Table 3, when the impedance value between the conductive layer 22 and the shielding layer 13 is greater than 80 mΩ, the shielding performance value of the shielding cable connection structure is less than 40 dB, which does not meet the requirements of the ideal value: and when the impedance value between the conductive layer 22 and the shielding layer 13 is less than 80 mΩ, the shielding performance values of the shielding cable connection structure all meet the requirement of the ideal value, and the trend is getting better and better, therefore, the inventor sets the impedance between the conductive layer 22 and the shielding layer 13 to be less than 80 mΩ.

In an embodiment, the conductive layer 22 is one or more selected from a metal insert, a conductive plating layer, a conductive coating layer, a conductive non-metal insert, and a conductive non-metal plastic part. A variety of materials are used to produce the conductive layer 22, and the material can be selected according to different use environments, different connector materials and different shielding effectiveness requirements, so that designers can carry out the design and material selection of the shielding cable connection structure in more ways.

In an embodiment, a transfer impedance of the conductive layer 22 is less than 100 mΩ, and the shielding effect of the conductive layer 22 is characterized usually by the transfer impedance of the shielding material, and the less the transfer impedance is, the better the shielding effect is. The transfer impedance of the conductive layer 22 is defined as the ratio of the differential mode voltage U induced by the shield per unit length to the current Is passing through the shield surface, i.e.,

Z_{T}=U/I_{S}, so that it can be understood that the transfer impedance of the conductive layer 22 converts the current of the conductive layer 22 into differential mode interference. The less the transfer impedance is, the better it is. That is, better shielding performance can be obtained by reducing the differential mode interference conversion.

In order to verify the influence of the conductive layer 22 having different transfer impedance values on the shielding effect of the shielding cable connection structure, the inventor uses the connector 5, the cable and the terminal 3 of the same specification, uses the conductive layer 22 having different transfer impedance values to make a series of samples of the shielding cable connection structure, to respectively test the shielding effect of the shielding cable connection structure, and the experimental results are shown in Table 4 below. In this embodiment, the shielding performance value of the shielding cable connection structure greater than 40 dB is the ideal value.

The test method of the shielding performance value is to use test instrument to output a signal value (this value is the test value 2) to the shielding cable, and to provide a detection device outside the shielding cable, and the detection device detects a signal value (this value is the test value 1). Shielding performance value is equal to the test value 2 minus the test value 1.

TABLE 4
Influence of transfer impedance of the conductive layer 22 on the shielding performance

| | Transfer impedance of the conductive layer 22 (mΩ) | | | | | | | | | | |
|---|---|---|---|---|---|---|---|---|---|---|---|
| Measurement parameter | 20 | 30 | 40 | 50 | 60 | 70 | 80 | 90 | 100 | 110 | 120 |
| Shielding performance | 78 | 75 | 71 | 66 | 62 | 58 | 53 | 48 | 42 | 31 | 27 |
| value (dB) | | | | | | | | | | | |

As can be seen from Table 4, when the transfer impedance value of the conductive layer 22 is greater than 100 mΩ, the shielding performance value of the shielding cable connection structure is less than 40 dB, which does not meet the requirements of the ideal value; and when the transfer impedance value of the conductive layer 22 is less than 100 mΩ, the shielding performance values of the shielding cable connection structure all meet the requirement of the ideal value, and the trend is getting better and better, therefore, the inventor sets the transfer impedance of the conductive layer 22 to be less than 100 mΩ.

Further, a material of the metal insert includes one or more selected from nickel, cadmium, zirconium, chromium, cobalt, manganese, aluminum, tin, titanium, zinc, copper, silver, gold, phosphorus, tellurium, and beryllium.

In order to demonstrate the effect of different materials of metal inserts on the electric conductivity of the conductive layer 22, the inventor adopts metal insert samples with the same specification, the same size and different materials, and tests the electric conductivity of the metal inserts respectively. The experimental results are shown in Table 5. In this embodiment, the electric conductivity of the metal insert greater than 99% is ideal.

TABLE 5
Influence of different materials of metal inserts on electric conductivity of the conductive layer 22
Different materials of metal inserts

| | | | | | | | | | | | | | | |
|---|---|---|---|---|---|---|---|---|---|---|---|---|---|---|
| | Cad- | Zir- | Chro- | | Man- | Alu- | | Tita- | | | | | Tellu- | Beryl- |
| Nickel | mium | conium | mium | Cobalt | ganese | minum | Tin | nium | Zinc | Copper | Silver | Gold | rium | lium |

Electric conductivity of the metal inserts (%)

| | | | | | | | | | | | | | | |
|---|---|---|---|---|---|---|---|---|---|---|---|---|---|---|
| 99.4 | 99.3 | 99.2 | 99.2 | 99.3 | 99.3 | 99.6 | 99.5 | 99.5 | 99.3 | 99.7 | 99.9 | 99.7 | 99.3 | 99.4 |

As can be seen from Table 5, the electric conductivity of the metal inserts made of selected metal materials is within the ideal value range. In addition, phosphorus is a non-metal material and cannot be directly used as material of the metal insert, but it can be added into other metals to form alloy to improve the conductive and mechanical properties of the metal itself. Therefore, the inventor sets that the material of the metal insert includes one or more selected from nickel, cadmium, zirconium, chromium, cobalt, manganese, aluminum, tin, titanium, zinc, copper, silver, gold, phosphorus, tellurium, and beryllium.

Further, a material of the conductive coating layer includes one or more selected from gold, silver, copper, nickel, titanium, tin, aluminum, cadmium, zirconium, chromium, cobalt, manganese, zinc, phosphorus, tellurium, beryllium, tin-lead alloy, silver-antimony alloy, palladium, palladium-nickel alloy, graphite-silver, graphene-silver, and silver-gold-zirconium alloy.

In order to demonstrate the effect of different materials of the conductive coating layer on the electric conductivity of the conductive layer 22, the inventor adopts conductive coating layer samples with the same specification, the same size and different materials, and tests the electric conductivity of the conductive coating layers respectively. The experimental results are shown in Table 6. In this embodiment, the electric conductivity of the conductive coating greater than 99% is ideal.

TABLE 6
Influence of different materials of the conductive coating layers on electric conductivity of the conductive layer 22
Different materials of conductive coating layer

| | | | | | | | | | | | | | | |
|---|---|---|---|---|---|---|---|---|---|---|---|---|---|---|
| | Cad- | Zir- | Chro- | | Man- | Alu- | | Tita- | | | | | Tellu- | Beryl- |
| Nickel | mium | conium | mium | Cobalt | ganese | minum | Tin | nium | Zinc | Copper | Silver | Gold | rium | lium |

Electric conductivity of the conductive coatings (%)

| | | | | | | | | | | | | | | |
|---|---|---|---|---|---|---|---|---|---|---|---|---|---|---|
| 99.4 | 99.3 | 99.2 | 99.2 | 99.3 | 99.3 | 99.6 | 99.5 | 99.5 | 99.3 | 99.7 | 99.9 | 99.7 | 99.4 | 99.4 |

As can be seen from Table 6, the electric conductivity of the metal inserts made of selected metal materials is within the ideal value range. In addition, phosphorus is a non-metal material and cannot be directly used as material of the conductive coating layer, but it can be added into other metals to form alloy to improve the conductive and mechanical properties of the metal itself. Therefore, the inventor sets that the material of the conductive coating layer includes one or more selected from nickel, cadmium, zirconium, chromium, cobalt, manganese, aluminum, tin, titanium, zinc, copper, silver, gold, phosphorus, tellurium, and beryllium.

Further, a material of the conductive plating layer includes one or more layer gold, silver, copper, nickel, titanium, tin, aluminum, cadmium, zirconium, chromium, cobalt, manganese, zinc, phosphorus, tellurium, beryllium, tin-lead alloy, silver-antimony alloy, palladium, palladium-nickel alloy, graphite-silver, graphene-silver, and silver-gold-zirconium alloy.

In order to demonstrate the effect of different materials of the conductive plating layer on the electric conductivity of the conductive layer 22, the inventor adopts connector samples having the conductive plating layers with the same specification, the same size and different materials, and tests the electric conductivity of the conductive plating layer respectively. The experimental results are shown in Table 7. In this embodiment, the electric conductivity of the conductive plating layer greater than 99% is ideal.

TABLE 7
Influence of different materials of the conductive plating layers on electric conductivity of the conductive layer 22
Different materials of conductive plating layers

| | | | | | | | | | | | | |
|---|---|---|---|---|---|---|---|---|---|---|---|---|
| | | | | Tita- | | Alu- | Cad- | Zir- | Chro- | | Man- | |
| Gold | Silver | Copper | Nickel | nium | Tin | minum | mium | conium | mium | Cobalt | ganese | Zinc |

Electric conductivity of the conductive platings (%)

| | | | | | | | | | | | | |
|---|---|---|---|---|---|---|---|---|---|---|---|---|
| 99.8 | 99.9 | 99.8 | 99.5 | 99.5 | 99.5 | 99.6 | 99.3 | 99.2 | 99.2 | 99.3 | 99.3 | 99.3 |

Different materials of conductive plating layers

| | | | | | | | | |
|---|---|---|---|---|---|---|---|---|
| | | | Silver- | | Palladium- | | | Silver-gold- |
| Tellu- | Beryl- | Tin-lead | antimony | | nickel | Graphite- | Graphene- | zirconium |
| rium | lium | Alloy | Alloy | Palladium | Alloy | silver | silver | Alloy |

Electric conductivity of the conductive platings (%)

| | | | | | | | | |
|---|---|---|---|---|---|---|---|---|
| 99.4 | 99.4 | 99.5 | 99.9 | 99.2 | 99.4 | 99.9 | 99.9 | 99.9 |

As can be seen from Table 7, the electric conductivity of the conductive plating layer made of selected metal materials is within the ideal value range. In addition, phosphorus is a non-metal material and cannot be directly used as material of the conductive plating layer, but it can be added into other metals to form alloy to improve the conductive and mechanical properties of the metal itself. Further, the inventor sets that the material of the conductive plating layer includes one or more selected from gold, silver, copper, nickel, titanium, tin, aluminum, cadmium, zirconium, chromium, cobalt, manganese, zinc, tin-lead alloy, silver-antimony alloy, palladium, palladium-nickel alloy, graphite-silver, graphene-silver, and silver-gold-zirconium alloy.

Further, a material of the conductive non-metal insert is one or combination of more selected from a conductive ceramic, a carbon-containing conductor, a solid electrolyte, a mixed conductor, and a conductive polymer material. Further, the carbon-containing conductor is one or more selected from graphite powder, carbon nanotube material, and graphene material.

In order to demonstrate the effect of different materials of the conductive non-metal insert on the electric conductivity of the conductive layer 22, the inventor adopts connector samples having the conductive non-metal inserts with the same specification, the same size and different materials, and tests the electric conductivity of the conductive non-metal inserts respectively. The experimental results are shown in Table 8 below. In this embodiment, the electric conductivity of the conductive non-metal insert greater than 99% is ideal.

TABLE 8
Influence of different materials of conductive non-metal inserts
on electric conductivity of the conductive layer 22
Different materials of conductive plating layer

| | | | | | | |
|---|---|---|---|---|---|---|
| | | Carbon | | | | Conductive |
| Conductive | Graphite | nanotube | Graphene | Solid | Mixed | polymer |
| ceramic | powder | material | material | electrolyte | conductor | material |

Electric conductivity of the metal inserts (%)

| | | | | | | |
|---|---|---|---|---|---|---|
| 99.4 | 99.4 | 99.9 | 99.9 | 99.5 | 99.3 | 99.6 |

As can be seen from Table 8 above, the electric conductivity of the conductive non-metal insert made of the selected material is within the ideal value range. Therefore, the inventor sets that the material of the conductive non-metal insert is one or combination of more selected from a conductive ceramic, a carbon-containing conductor, a solid electrolyte, a mixed conductor, and a conductive polymer material. Further, the carbon-containing conductor is one or more selected from graphite powder, carbon nanotube material, and graphene material.

Further, the conductive non-metal plastic part is polymer material containing metal particles. The material of the metal particles includes one or more selected from nickel, cadmium, zirconium, chromium, cobalt, manganese, aluminum, tin, titanium, zinc, copper, silver, gold, phosphorus, tellurium, and beryllium. A material of the polymer material is one or more selected from polyvinyl polyethylene, chloride, polyamide, polytetrafluoroethylene, tetrafluoroethylene/hexafluoroethylene copolymer, ethylene/tetrafluoroethylene copolymer, polypropylene, polyvinylidene fluoride, polyurethane, polyterephthalic acid, polyurethane elastomers, styrene block copolymer, perfluoroalkoxy alkane, chlorinated polyethylene, polyphenylene sulfide, polystyrene, silicone rubber, crosslinked polyolefin, ethylene propylene rubber, Ethylene/vinyl acetate copolymer, chloroprene rubber, natural rubber, styrene butadiene rubber, nitrile butadiene rubber, silicone rubber, cis-polybutadiene, isoamyl rubber, ethylene propylene rubber, chloroprene rubber, butyl rubber, fluororubber, polyurethane rubber, polyacrylate rubber, chlorosulfonated polyethylene rubber, epichlorohydrin rubber, chlorinated polyethylene rubber, chloro-sulfide rubber, styrene butadiene rubber, butadiene rubber, hydrogenated nitrile rubber, polysulfide rubber, crosslinked polyethylene, polycarbonate, polysulfone, polyphenyl ether, polyester, phenolic resin, urea formaldehyde, styrene-acrylonitrile copolymer, polymethacrylate, polyformaldehyde resin.

Further, the conductive non-metal plastic part is manufactured by one or more selected from an extrusion process, an injection molding process, a dip molding process, a blow molding process, a foaming process, a spraying process, a printing process and a 3D printing process.

The injection molding process refers to the process of making a semi-finished part of a certain shape by pressurizing, injecting, cooling and disconnecting the molten raw materials.

The dipping process refers to a process of electrically heating the workpiece to a certain temperature, and then dipping the workpiece into the dipping liquid to solidify the dipping liquid on the workpiece.

The blow molding process refers to using an extruder to extrude a tubular billet, putting the tubular billet in a mold while it's still hot, blowing compressed air into the mold to blow up the tubular billet to make it have the mold cavity shape, and getting a product after cooling and shaping the tubular billet. The blow molding process has the advantages that it is suitable for a variety of plastics, can produce large products, can realize high production efficiency, uniform billet temperature and less equipment investment.

The foaming process refers to that in the foam forming process or the foamed polymer material, the honeycomb or porous structure is formed through the addition and reaction of physical foaming agent or chemical foaming agent. The basic steps of foam forming include forming a foam core, growing or expanding the foam core, and stabilizing the foam core. Under the given temperature and pressure conditions, the solubility of the gas decreases to reach a saturation state, so that the excess gas is expelled and bubbles form, thus achieving nucleus formation.

The spraying process is a coating method in which the spray material is dispersed into uniform and fine droplets through a spray gun or a disc atomizer with the help of pressure or centrifugal force and is applied on the surface of the coated material. The spraying process can be categorized as air spraying, airless spraying, electrostatic spraying and various derivative methods of the above basic spraying forms.

The printing process refers to a method in which ink or other viscous fluid materials are transferred to the surface of the coated material using a printing plate, and which includes silk-screen printing, relief printing, flexographic printing, intaglio printing or planographic printing.

The 3D printing process is a kind of rapid proto-typing technology, also known as additive manufacturing, and is a technology in which an object is constructed by printing layer by layer using an adhesive material such as a powdered metal or plastic based on a digital model file.

In an embodiment, a material of the insulating housing 24 includes one or more selected from polyvinyl chloride, polyethylene, polyamide, polytetrafluoroethylene, tetrafluoroethylene/hexafluoroethylene copolymer, ethylene/tetrafluoroethylene copolymer, polypropylene, polyvinylidene fluoride, polyurethane, polyterephthalic acid, polyurethane elastomers, styrene block copolymer, perfluoroalkoxy alkane, chlorinated polyethylene, polyphenylene sulfide, polystyrene, silicone rubber, crosslinked polyolefin, ethylene propylene rubber, Ethylene/vinyl acetate copolymer, chloroprene rubber, natural rubber, styrene butadiene rubber, nitrile butadiene rubber, silicone rubber, cis-polybutadiene, isoamyl rubber, ethylene propylene rubber, chloroprene rubber, butyl rubber, fluororubber, polyurethane rubber, polyacrylate rubber, chlorosulfonated polyethylene rubber, epichlorohydrin rubber, chlorinated polyethylene rubber, chloro-sulfide rubber, styrene butadiene rubber, butadiene rubber, hydrogenated nitrile rubber, polysulfide rubber, crosslinked polyethylene, polycarbonate, polysulfone, polyphenyl ether, polyester, phenolic resin, urea formaldehyde, styrene-acrylonitrile copolymer, polymethacrylate, and polyformaldehyde resin.

In an embodiment, the material of the insulating protective layer 25 includes one or more selected from polyvinyl chloride, polyethylene, polyamide, polytetrafluoroethylene, tetrafluoroethylene/hexafluoroethylene copolymer, ethylene/tetrafluoroethylene copolymer, polypropylene, polyvinylidene fluoride, polyurethane, polyterephthalic acid, polyurethane elastomers, styrene block copolymer, perfluoroalkoxy alkane, chlorinated polyethylene, polyphenylene sulfide, polystyrene, silicone rubber, crosslinked polyolefin, ethylene propylene rubber, Ethylene/vinyl acetate copolymer, chloroprene rubber, natural rubber, styrene butadiene rubber, nitrile butadiene rubber, silicone rubber, cis-polybutadiene, isoamyl rubber, ethylene propylene rubber, chloroprene rubber, butyl rubber, fluororubber, polyurethane rubber, polyacrylate rubber, chlorosulfonated polyethylene rubber, epichlorohydrin rubber, chlorinated polyethylene rubber, chloro-sulfide rubber, styrene butadiene rubber, butadiene rubber, hydrogenated nitrile rubber, polysulfide rubber, crosslinked polyethylene, polycarbonate, polysulfone, polyphenyl ether, polyester, phenolic resin, urea formaldehyde, styrene-acrylonitrile copolymer, polymethacrylate, and polyformaldehyde resin.

In an embodiment, a material of the shielding device 15 includes one or more selected from nickel, cadmium, zirconium, chromium, cobalt, manganese, aluminum, tin, titanium, zinc, copper, silver, gold, phosphorus, tellurium, and beryllium.

In an embodiment, a material of the conductive elastic sheet 4 contains one or more selected from nickel, cadmium, zirconium, chromium, cobalt, manganese, aluminum, tin, titanium, zinc, copper, silver, gold, phosphorus, tellurium, and beryllium.

It can be seen from the above experiments that the corresponding electric conductivity of the selected metal materials meets the ideal value, thus the selected metal materials can also be used as the materials of the shielding device 15 and the conductive elastic sheet 4.

The conductive layer 22 provided in the second inner cavity 23 is exposed. When the shielding cable connection structure is connected to the mating plug-in terminal, the exposed conductive layer 22 in the second inner cavity 23 is in contact with and electrically connected to the exposed conductive layer 22 of the mating plug-in terminal, so as to be connected to the shielding net of the cable at the mating plug-in terminal, which thus ensures the smooth connection between the mating plug-in terminal and the shielding layer 13 of the shielding cable, may reduce the grounding wire and make the connection more convenient, thereby saving processing and assembly time. The conductive elastic sheet 4 is cylindrical in shape.

The connector 5 may be of a single layer structure, that is, the housing of the connector 5 is a conductive layer 22: the connector 5 may also be of a multilayer structure, including a conductive layer 22 and an insulating protective layer 25.

The foregoing is merely an illustrative embodiment of the disclosure and is not intended to limit the scope of the disclosure. Any equivalent changes and modifications made by those skilled in the art without departing from the concepts and principles of the present disclosure shall fall within the scope of the present disclosure.

1. A shielding cable connection structure comprising a connector and a shielding cable, wherein the shielding cable comprises a conductor core and a shielding layer, the connector is provided therein with a first inner cavity for accommodating the shielding cable, the connector comprises a conductive layer, and the conductive layer is provided on an inner surface of the first inner cavity and is electrically connected to the shielding layer.

2. The shielding cable connection structure according to claim 1, wherein the conductive layer wraps at least part of the periphery of the shielding layer.

3. The shielding cable connection structure according to claim 1, further comprising a terminal and an insulating housing, wherein the terminal comprises a connection end, and the connection end is electrically connected to the conductor core;
the insulating housing is provided with a second inner cavity for accommodating the terminal; and
the conductive layer wraps at least part of the periphery of the insulating housing.

4. The shielding cable connection structure according to claim 1, wherein the connector comprises an insulating protective layer, and the insulating protective layer is provided on at least part of the periphery of the conductive layer.

5. The shielding cable connection structure according to claim 1, wherein the shielding cable further comprises an inner insulating layer within which the conductor core is provided, and the shielding layer wraps at least part of the periphery of the inner insulating layer.

6. The shielding cable connection structure according to claim 1, wherein the shielding cable further comprises an outer insulating layer, the shielding layer is provided within the outer insulating layer, and an end of the shielding layer that is located in the first inner cavity is folded over outwards to wrap at least part of the periphery of the outer insulating layer.

7. The shielding cable connection structure according to claim 1, wherein the shielding cable further comprises a shielding device which is provided on at least part of the periphery of the shielding layer, and the shielding layer is electrically connected to the conductive layer through the shielding device.

8. (canceled)

9. The shielding cable connection structure according to claim 7, wherein the shielding device comprises a first collar and a second collar that are distributed longitudinally, an inner diameter of the first collar is less than an inner diameter of the second collar, the shielding layer is folded over outwards to wrap at least part of the periphery of the first collar, and the shielding layer is fixedly connected to the first collar, and the second collar is electrically connected to the conductive layer.

10. The shielding cable connection structure according to claim 1, further comprising a conductive elastic sheet provided on the inner surface of the first inner cavity, the conductive elastic sheet is in contact connection with the shielding layer and exerts pressure on the shielding layer.

11. The shielding cable connection structure according to claim 7, further comprising a conductive elastic sheet provided on the inner surface of the first inner cavity, the conductive elastic sheet is in contact connection with the shielding device and exerts pressure on the shielding device.

12. The shielding cable connection structure according to claim 10, wherein the pressure exerted by the conductive elastic sheet is in a range of 0.3 N to 95 N.

13. The shielding cable connection structure according to claim 10, wherein one end of the conductive elastic sheet is fixed on the inner surface of the first inner cavity, and the other end of the conductive elastic sheet has a minimum inner diameter in a free state which is less than or equal to an outer diameter of the shielding layer.

14. The shielding cable connection structure according to claim 11, wherein one end of the conductive elastic sheet is fixed on the inner surface of the first inner cavity, and the other end of the conductive elastic sheet has a minimum inner diameter in a free state which is less than or equal to an outer diameter of the shielding device.

15. The shielding cable connection structure according to claim 10, wherein both ends of the conductive elastic sheet are fixed on the inner surface of the first inner cavity, and a middle portion of the conductive elastic sheet has a minimum inner diameter in a free state which is less than or equal to an outer diameter of the shielding layer.

16. The shielding cable connection structure according to claim 11, wherein both ends of the conductive elastic sheet are fixed on the inner surface of the first inner cavity, and a middle portion of the conductive elastic sheet has a minimum inner diameter in a free state which is less than or equal to an outer diameter of the shielding device.

17. The shielding cable connection structure according to claim 13, wherein the conductive elastic sheet comprises a base strip and a plurality of elastic sheets, the base strip is fixed on the inner surface of the first inner cavity, and one ends of the plurality of elastic sheets are fixed on the base strip.

18. The shielding cable connection structure according to claim 17, wherein the number of the base strip is two, both of the base strips are fixed on the inner surface of the first inner cavity, and both ends of each of the plurality of elastic sheets are fixed on the two base strips respectively.

19. (canceled)

20. The shielding cable connection structure according to claim 1, wherein an impedance between the conductive layer and the shielding layer is less than 80 mΩ.

21. (canceled)

22. The shielding cable connection structure according to claim 1, wherein a transfer impedance of the conductive layer is less than 100 mΩ.

23-33. (canceled)

34. The shielding cable connection structure according to claim 11, wherein the pressure exerted by the conductive elastic sheet is in a range of 0.3 N to 95 N.
